(19) United States
(12) Patent Application Publication
(10) Pub. No.: US 2006/0160647 A1
(43) Pub. Date: Jul. 20, 2006

(54) Molded composite pulley

(75) Inventor: Jeffrey A. Swane, Christian County, MO (US)

Correspondence Address: DAYCO PRODUCTS, LLC, 1 PRESTIGE PLACE, MIAMISBURG, OH, 45342, US

(73) Assignee: Dayco Products, LLC

(21) Appl. No.: 11/040,284

(22) Filed: Jan. 20, 2005

(51) Int. Cl. F16H 55/36; B65G 15/08; B65G 15/40

(52) U.S. Cl. 474/166

(57) ABSTRACT

A pulley for a belt drive system includes a belt-running surface and a core disposed to radially support the belt-running surface. The belt-running surface is comprised of a first material including a first polymer resin and the core is comprised of a second material including a second polymer resin, where the first material and the second material are different.

### TECHNICAL FIELD

The present application relates generally to pulleys, and more particularly to a pulley having portions molded of different materials.

### BACKGROUND

Idler pulleys are frequently employed for automotive use, e.g., to tension a belt of a belt drive system. In such cases, the idler pulley can be connected to a tensioner pivot arm of a belt tensioner that is fixedly mounted within an automobile. Pulleys formed of plastic resin have been used in such automobile applications, or other applications that utilize belt-driven accessory drives and plastic pulleys. Typically, the resin pulleys are molded from a single material.

### SUMMARY

According to the present invention a pulley for a belt drive system is provided that comprises at least two distinct materials. A first material may be selected for its wear resistant properties and may be located at a belt-running surface of the pulley. A second material may be selected for its strength characteristics and may be located so as to radially support the belt-running surface of the pulley.

In one aspect, a pulley for a belt drive system includes a belt-running surface and a core disposed to radially support the belt-running surface. The belt-running surface is comprised of a first material including a first polymer resin and the core is comprised of a second material including a second polymer resin, where the first material and the second material are different.

In another aspect, a pulley for a drive belt system includes a molded ring having a belt-running surface over which a belt is to be engaged and a molded core disposed to radially support the molded ring and configured to house a bearing. The molded ring is comprised of a first material including a first polymer resin. The molded core is comprised of a second material including a second polymer resin. According to this aspect the first material is selected so as to possess greater wear resistance than the second material.

In still another aspect, a method of forming a pulley for a belt-drive system is provided. The method includes molding an annular belt-running surface comprised of a first material and molding a core comprised of a second material within a central opening of the belt-running surface such that the core is disposed to radially support the belt-running surface. According to this aspect the first material is different than the second material.

In one or more of the above aspects, the second or a third material is used for bearing/insert retention.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a side view of a pulley according to one embodiment;

FIG. 2 is section view along line 2-2 of FIG. 1;

FIG. 3 is a section view of a pulley according to a second embodiment;

FIG. 4 schematically depicts an apparatus for forming a pulley;

FIG. 5 is a flow diagram of a method of molding a pulley utilizing the apparatus of FIG. 4;

FIGS. 6 and 6A are side and detail views, respectively, of an embodiment of a ring including notches;

FIGS. 7 and 7A are side and detail views, respectively, of an embodiment of a ring including ribs;

FIG. 8 is a section view of a pulley according to a third embodiment; and

FIG. 9 is a section view of a pulley according to a fourth embodiment.

### DETAILED DESCRIPTION

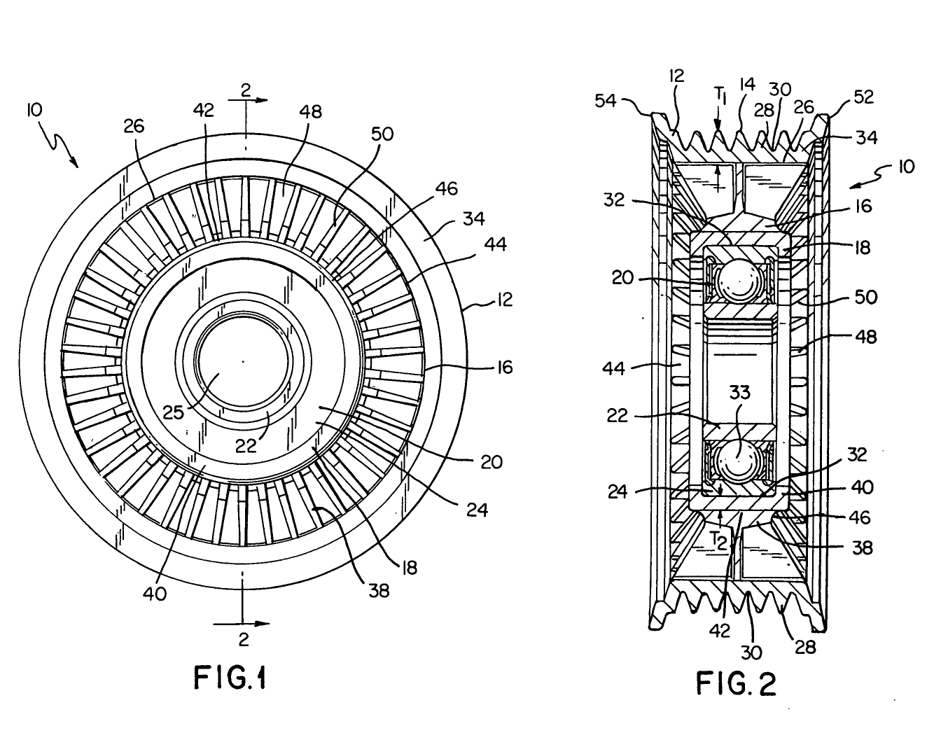

FIGS. 1 and 2 depict a pulley 10 having a molded outer ring 12 that includes a belt-running surface 14 (FIG. 2) for engaging a belt, such as an automotive power transmission belt (not shown), a molded inner core 16 that radially supports the ring and a bearing retainer 18 centrally located within the core. Located within the bearing retainer 18 is a bearing 20 that includes an inner race 22, an outer race 24 and an opening 25. The bearing 20 is secured within the bearing retainer 18 such that the ring 12 including the belt-running surface 14, core 16, bearing retainer and outer race 24 can rotate together relative to the inner race 22. As will be described in greater detail below, the pulley 10 is formed from at least two distinct materials that can be selected to optimize certain physical properties of the pulley, such as wear resistance (e.g., of the belt-running surface 14) and compressive strength (e.g., of the core 16). As used herein, “material” refers to the substance or substances out of which a thing is made and can refer to a mixture such as a composite including filler disposed within a resin matrix.

Referring to FIG. 2, the outer ring 12 of pulley 10 including the belt-running surface 14 is joined to the core 16 along an annular interface 26 between the core and the ring. The belt-running surface 14 of the ring 12 has an undulating contour of peaks 28 separated by valleys 30. The contour of the belt-running surface 14 is formed to correspond with a mating contour of a belt (not shown) that engages the belt-running surface during use. These mating contours can reduce slippage between the belt and the belt-running surface 14 during operation. As an alternative to undulations, the belt-running surface 14 may be formed for use with other input devices, such as a smooth belt, a toothed belt, a V-shaped belt, etc.

The core 16 radially supports the ring 12 including the belt-running surface 14. The core 16 includes an outer wall 44, an inner wall 46 and a web 48 of supports 50 extending between the inner and outer walls. The bearing retainer 18 is centrally disposed in the core 16 and is joined to the inner wall 46 of the core along an inner annular interface 42 between the core and the bearing retainer.

As mentioned above, bearing 20 allows rotational movement of the core 16 and the outer ring 12 relative to the inner race 22. The bearing 20, which is shown as a ball type bearing, includes an outer race 24, which may be insert molded onto a bearing retainer surface 32 of the bearing retainer 18 (see FIG. 2). Alternatively, the bearing can be press-fit into the bearing retainer 18, e.g., after molding. The bearing 20 may alternatively be a journal bearing or a roller bearing, and may alternatively include other suitable elements 33, such as rollers or a cartridge. In another embodiment, the bearing retainer surface 32 can itself form a bearing sleeve, e.g., formed of a bearing grade material, or an insert, such as a sleeve (e.g., formed of metal), may be retained in the retainer 18.

According to at least one aspect of the invention, the materials that form the belt-running surface 14, core 16 and, in some embodiments, the bearing retainer surface 32 of the pulley 10 are selected to optimize certain physical properties of the molded pulley. Referring to the embodiment depicted in FIG. 2, the pulley 10 is a composite of three distinct materials with the belt-running surface 14 formed by a first material 34, the core 16 formed by a second material 38, and the bearing retainer 18 formed by a third material 40. In some embodiments, each of the three materials 34, 38, and 40 is different from the other two materials. In other embodiments, the pulley 10 includes only two different materials with the core 16 and bearing retainer 18 formed by a single material that is different from a material forming the belt-running surface 14. The pulley 10 can also include more than three materials.

Because the belt-running surface 14 is in contact with a belt during use, it may be desirable to form the belt-running surface from a material having relatively high wear resistance (e.g., compared to material forming the core 16), which in some cases may also reduce belt wear. Suitable materials for forming the belt-running surface 14 of ring 12 include, for example, polymers such as nylon 6, nylon 6/6, nylon 6/6/6 copolymer or blend, nylon 4/6, polypropylene, polyester, acetal, polyetherimide, polysulfone, polyphenylene sulfide, polyether sulfone, polyetheretherketone and polythalamide. The material forming the belt running surface 14 can be filled or unfilled. In cases where a filled polymer is selected, optional suitable fillers may be added. For example, suitable fillers include glass fiber or bead (e.g., about 0 to about 50 weight percent), carbon fiber (e.g., about 0 to about 40 weight percent), aramid fiber (e.g., about 0 to about 25 weight percent), mineral fiber (e.g., about 0 to about 60 weight percent), molybdenum disulfide (e.g., about 0 to about 5 weight percent), graphite (e.g., about 0 to about 20 weight percent), PTFE (e.g., about 0 to about 30 weight percent), and silicone (e.g., between about 0 and about 5 weight percent).

The second material 38 forming the core 16 and the third material 40 (when applicable) forming the bearing retainer 18 can be a material having a relatively high strength, especially compressive strength, (e.g., compared to material forming the belt-running surface) to optimize radial support for the belt-running surface 14 and the bearing 20. Suitable materials for forming the core 16 and bearing retainer 18 include, for example, polymers such as nylon 6, nylon 6/6, nylon 6/6/6 copolymer or blend, nylon 4/6, polypropylene, polyester, acetal, polyetherimide, polysulfone, polyphenylene sulfide, polyether sulfone, polyetheretherketone and polythalamide. To enhance the compressive strength of the mold material a filler may be included, such as, for example, short or long glass fiber (e.g., about 0 to about 60 weight percent), carbon fiber (e.g., about 0 to about 40 weight percent), aramid fiber (e.g., about 0 to about 25 weight percent), mineral fiber (e.g., about 0 to about 60 weight percent) and molybdenum disulfide (e.g., about 0 to about 5 weight percent).

As shown in FIGS. 2, 3, 8 and 9 the thickness T₁ of the belt-running surface 14 and the thickness T₂ of the bearing retainer surface 32 can also be selected to optimize physical properties of the pulley. Typically, however, T₁ and T₂ are at least 0.005 inches.

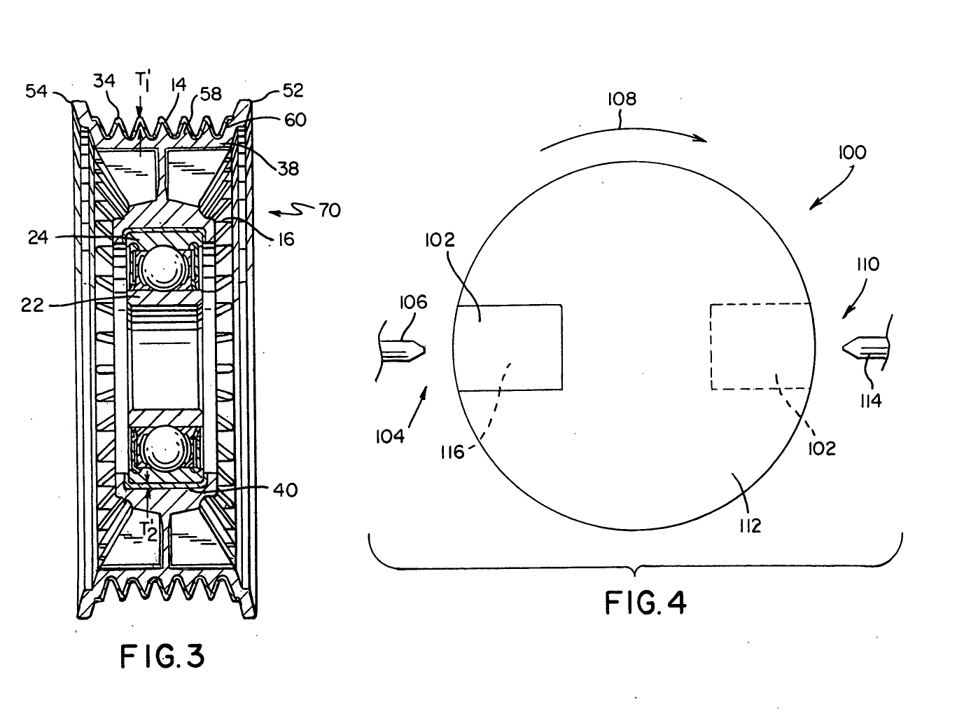

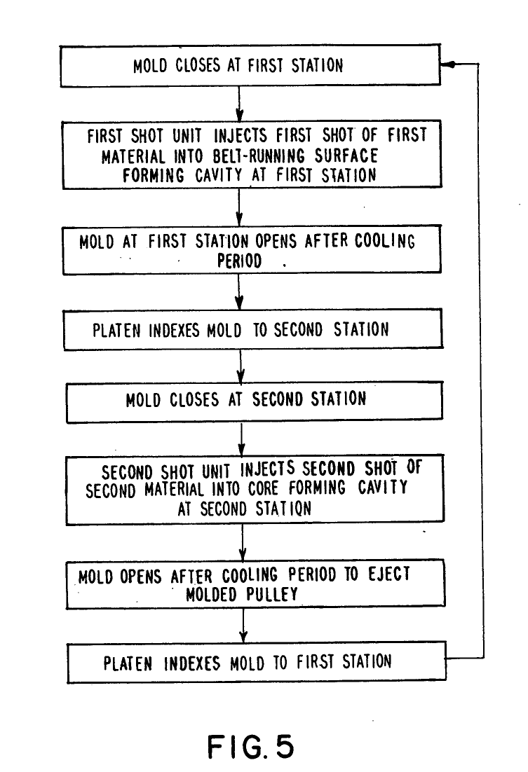

Pulleys according to the present invention (e.g., of FIGS. 1 and 3) can be formed by a multi-shot molding process using, for example, a rotary platen mold assembly. One suitable rotary platen mold assembly 100 is depicted in FIG. 4 and is available from MGS Mfg. Group Inc., Germantown, Wis.

Referring to FIG. 4, with a rotary platen mold 102 in a first station 104, the belt-running surface 14 may be formed by injecting a first amount of polymer resin (e.g., unfilled nylon 6 or unfilled nylon 6/6) using a first shot unit 106 into a cavity (not shown) forming the outer ring 12. The injected polymer resin may then be cooled within the ring-forming cavity and the rotary platen mold 102 can be indexed in the direction of arrow 108 to a second station 110 using rotary platen assembly 112. With the rotary platen mold 102 in the second station 110 (shown by dotted lines), a second amount of a different material (e.g., glass filled nylon 6 or glass filled nylon 6/6) may be injected into a core-forming cavity (not shown) of the rotary platen mold using a second shot unit 114 to form the core 16. The material forming the core can then be cooled within the core-forming cavity and the molded pulley structure can be removed from the rotary platen mold, e.g., with the rotary platen mold in the second station. As is known in the art, the rotary platen mold assembly 100 can further include multiple molds to allow simultaneous part formation and therefore improved manufacturing efficiency. In some cases, the core 16 can be molded before molding the belt-running surface 14.

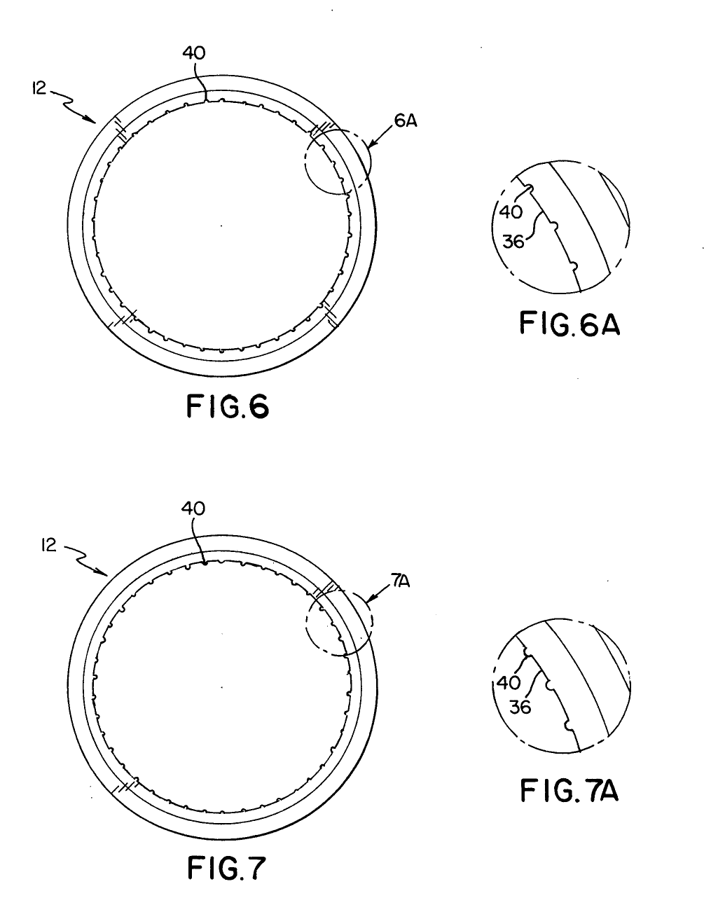

Once molded, the first and second materials may be mechanically interlocked or bonded along the annular interface between the first and second materials. Referring also to FIGS. 6-7A, in some embodiments, the outer ring 12 can be molded (e.g., at station 104 of FIG. 4) to include interface structures 40 (e.g., ribs, grooves, etc.) extending from lower surface 36, which can enhance bonding between the first and second materials 34 and 38. In some cases, bearing retainer 18 and/or core 16 can be molded to include interface structures 40. In certain embodiments, the bearing 20 can be inserted into the rotary platen mold (e.g., with the rotary platen mold in the first or second stations) during the molding process to allow material forming the bearing retainer surface to bond to the bearing. As an alternative to interlocking or bonding the first and second materials along an annular interface, the pulley may be molded to include a transition from the first material to the second material, forming a relatively undefined boundary between the first and second materials. In some embodiments, an intermediate bonding layer (not shown) may be located between the first and second materials.

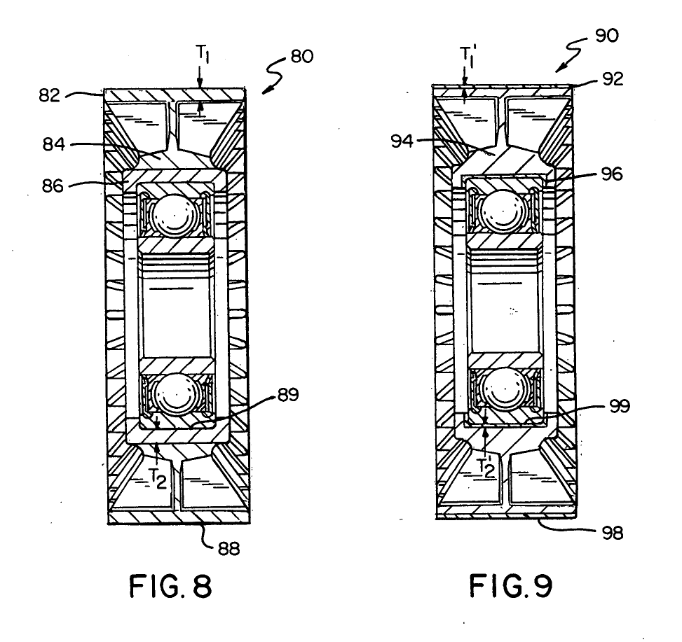

A number of detailed embodiments have been described. Nevertheless, it will be understood that various modifications may be made. For example, referring to FIGS. 8 and 9, the belt-running surface 88 may be formed to accommodate a flat automotive belt. In some embodiments, the belt-running surface 14 and core 16 are molded using a single cavity or using multiple molds where one portion of the pulley (e.g., the core or belt-running surface) is formed in a first mold and then that portion is transferred (e.g., manually or mechanically) to a second, different mold where a second, different portion of the pulley is formed. As noted above, variations are possible. Accordingly, other embodiments are within the scope of the following claims.

What is claimed is:

1. A pulley for a belt drive system, the pulley comprising:
a belt-running surface; and
a core disposed to radially support the belt-running surface;
wherein the belt-running surface is comprised of a first material including a first polymer resin;
wherein the core is comprised of a second material including a second polymer resin; and
wherein the first material and the second material are different.

2. The pulley of claim 1, wherein the first resin and second resin are different.

3. The pulley of claim 1, wherein the first material further comprises a filler dispersed within the first resin.

4. The pulley of claim 1, wherein the second material further comprises a filler dispersed within the second resin.

5. The pulley of claim 1, wherein the first polymer resin and the second polymer resin are the same, and wherein the second material further comprises a filler dispersed within the second resin.

6. The pulley of claim 5, wherein the first material further comprises a filler dispersed within the first resin, and wherein the filler dispersed within the first resin is different than the filler dispersed within the second resin.

7. The pulley of claim 1, wherein the belt-running surface has a thickness of at least 0.005 inches.

8. The pulley of claim 1, wherein the belt-running surface comprises a molded ring.

9. The pulley of claim 8, wherein the core is molded inside a central opening of the molded ring.

10. The pulley of claim 1, wherein the core comprises a retainer portion that defines a retainer surface, the retainer portion comprising a third material that is different from the second material.

11. The pulley of claim 10, wherein the third material comprises a third resin.

12. The pulley of claim 11, wherein the retainer surface has a thickness of at least 0.005 inches.

13. The pulley of claim 10, wherein the third material is different from the first material.

14. The pulley of claim 1, wherein the first polymer resin comprises nylon, polypropylene, polyester, acetal, polyetherimide, polysulfone, polyphenylene sulfide, polyether sulfone, polyetheretherketone or polythalamide.

15. The pulley of claim 4, wherein the second polymer resin comprises nylon, polypropylene, polyester, acetal, polyetherimide, polysulfone, polyphenylene sulfide, polyether sulfone, polyetheretherketone or polythalamide, and the filler comprises glass fiber, carbon fiber, aramid fiber, mineral filler or molybdenum disulfide.

16. The pulley of claim 1, wherein the belt-running surface is flat or grooved.

17. A pulley for a belt drive system comprising:
a molded ring having a belt-running surface over which a belt is to be engaged; and
a molded core disposed to radially support the molded ring and configured to house a bearing;
wherein the molded ring is comprised of a first material including a first polymer resin;
wherein the molded core is comprised of a second material including a second polymer resin;
and wherein the first material possesses greater wear resistance than the second material.

18. The pulley of claim 17, wherein the first and second polymer resins are different.

19. The pulley of claim 17, wherein the first material further comprises a filler dispersed within the first polymer resin.

20. The pulley of claim 17, wherein the second material further comprises a filler dispersed within the second polymer resin.

21. The pulley of claim 17, wherein the first polymer resin and the second polymer resin are the same, and wherein the second material further comprises a filler dispersed within the second polymer resin.

22. The pulley of claim 21, wherein the first material further comprises a filler dispersed within the first polymer resin and wherein the filler dispersed within the first polymer resin is different from the filler dispersed within the second polymer resin.

23. The pulley of claim 17, wherein the second material possesses greater compressive strength than the first material.

24. A method of forming a pulley for a belt drive system, the method comprising the steps of:
molding an annular belt-running surface comprised of a first material; and
molding a core comprised of a second material within a central opening of the belt-running surface such that the core is disposed to radially support the belt-running surface;
wherein the first material is different than the second material.

25. The method of claim 24, wherein the belt-running surface is molded prior to the step of molding the core.

26. The method of claim 24, wherein the core is molded prior to the step of molding the annular belt-running surface.

27. The method of claim 24, wherein the annular belt-running surface and the core are molded using a rotary platen mold.

28. The method of claim 27, wherein the rotary platen mold is configured to mold the annular belt-running surface in a first station and the core in a second station.

29. The method of claim 28, wherein the step of molding the annular belt-running surface comprises filling a first mold cavity of the rotary platen mold with the first material when the rotary platen mold is in the first station.

30. The method of claim 29, wherein the step of molding the core comprises, filling a second mold cavity of the rotary platen mold with the second material when the rotary platen mold is in the second station.

31. The method of claim 24, wherein the core is molded about a bearing.

32. The method of claim 24 further comprising the step of positioning a bearing within a bearing retaining portion of the core.
